(19) United States
(12) Patent Application Publication
(10) Pub. No.: US 2026/0237871 A1
(43) Pub. Date: Aug. 13, 2026

(54) INTERNAL THERMAL SWITCHES FOR BATTERY CELL CURRENT CONTROL

(71) Applicant: GM Global Technology Operations LLC, Detroit, MI (US)

(72) Inventors: Lu Huang, Troy, MI (US); Ziliang Zheng, Auburn Hills, MI (US); Linan Zheng, Troy, MI (US); William Yu Chen, Troy, MI (US); Ryan Curtis Sekol, Grosse Pointe Woods, MI (US); Fengkun Wang, Rochester Hills, MI (US)

(73) Assignee: GM Global Technology Operations LLC, Detroit, MI (US)

(21) Appl. No.: 19/051,567

(22) Filed: Feb. 12, 2025

(51) Int. Cl. H01M 50/581; B60L 3/00; B60L 3/04; B60L 50/60; H01M 50/204; H01M 50/249; H01M 50/55

(52) U.S. Cl. CPC H01M 50/581; B60L 3/0046; B60L 3/04; B60L 50/60; H01M 50/204; H01M 50/249; H01M 50/55; H01M 2200/10; H01M 2220/20

(57) ABSTRACT

A battery cell for a battery pack, the battery cell including a case, a terminal, an electrode stack, a current collector electrically coupled to the electrode stack, and an internal temperature-sensitive, electrically conductive component. The internal temperature-sensitive, electrically conductive component is configured to, when having a first temperature that does not satisfy a temperature threshold, have a first shape that electrically couples the current collector to the terminal and, when having a second temperature that satisfies the temperature threshold, change from the first shape to a second shape different from the first shape to disable the battery cell by electrically disconnecting the current collector from the terminal and electrically coupling the terminal to the case.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Electric vehicles (EVs) and hybrid electric vehicles (HEVs) include one or more electric motors and one or more battery packs configured to provide electric voltages for powering the electric motor(s) to propel the vehicle or to provide other electric voltages used by other components of the vehicle. Typically, the battery pack includes a plurality of battery cells.

The present disclosure relates generally to internal thermal switches for battery cell current control.

### SUMMARY

An aspect of the disclosure provides a vehicle including an electric motor and a battery pack configured to provide an electric voltage for powering the electric motor to propel the vehicle. The battery pack includes a plurality of battery cells. Each battery cell includes a case, a terminal, an electrode stack, a current collector electrically coupled to the electrode stack, and an internal temperature-sensitive, electrically conductive component. The internal temperature-sensitive, electrically conductive component is configured to, when having a first temperature that does not satisfy a temperature threshold, have a first shape that electrically couples the current collector to the terminal, and, when having a second temperature that satisfies the temperature threshold, change from the first shape to a second shape different from the first shape to disable the battery cell by electrically disconnecting the current collector from the terminal and electrically coupling the terminal to the case.

Implementations of the disclosure may include one or more of the following optional features. In some implementations, the terminal includes a negative terminal of the battery cell. In some examples, each battery cell also includes a second terminal, a second current collector electrically coupled to the electrode stack, and a second internal temperature-sensitive, electrically conductive component. The second internal temperature-sensitive, electrically conductive component configured to, when having a third temperature that does not satisfy a second temperature threshold, have a third shape, and, when having a fourth temperature that satisfies the second temperature threshold, change from the third shape to a fourth shape different from the third shape to electrically couple the second terminal to the case. In some implementations, the terminal is a negative terminal of the battery cell and the second terminal is a positive terminal of the battery cell. In some examples, the case is electrically coupled to a second terminal of the battery cell.

The internal temperature-sensitive, electrically conductive component may include a shape-memory alloy configured to undergo a phase transformation when the internal temperature-sensitive, electrically conductive component has the second temperature that satisfies the temperature threshold. Alternatively, the internal temperature-sensitive, electrically conductive component may include a bimetallic strip configured to deflect when the internal temperature-sensitive, electrically conductive component has the second temperature that satisfies the temperature threshold. Alternatively, the internal temperature-sensitive, electrically conductive component may include a bimetallic strip configured to bend when the internal temperature-sensitive, electrically conductive component has the second temperature that satisfies the temperature threshold. Alternatively, the internal temperature-sensitive, electrically conductive component may include two sub-components configured to bend away from each other when the internal temperature-sensitive, electrically conductive component has the first temperature that does not satisfy the temperature threshold, and bend toward each other when the internal temperature-sensitive, electrically conductive component has the second temperature that satisfies the temperature threshold.

In some implementations, each battery cell also includes a locking mechanism configured to hold the internal temperature-sensitive, electrically conductive component in the second shape when the battery cell cools. In some examples, the battery pack is configured to continue to provide the electric voltage or a second electric voltage while one or more of the battery cells are disabled.

Another aspect of the disclosure provides a battery cell for a battery pack. The battery cell includes a case, a terminal, an electrode stack, a current collector electrically coupled to the electrode stack, and an internal temperature-sensitive, electrically conductive component. The internal temperature-sensitive, electrically conductive component is configured to, when having a first temperature that does not satisfy a temperature threshold, have a first shape that electrically couples the current collector to the terminal, and, when having a second temperature that satisfies the temperature threshold, change from the first shape to a second shape different from the first shape to disable the battery cell by electrically disconnecting the current collector from the terminal and electrically coupling the terminal to the case.

Implementations of the disclosure may include one or more of the following optional features. In some implementations, the battery cell also includes a second terminal, a second current collector electrically coupled to the electrode stack, and a second internal temperature-sensitive, electrically conductive component. The second internal temperature-sensitive, electrically conductive component configured to, when having a third temperature that does not satisfy a second temperature threshold, have a third shape, and, when having a fourth temperature that satisfies the second temperature threshold, change from the third shape to a fourth shape different from the third shape to electrically couple the second terminal to the case. In some implementations, the terminal is a negative terminal of the battery cell and the second terminal is a positive terminal of the battery cell. In some examples, the case is electrically coupled to a second terminal of the battery cell. In some implementations, the battery cell also includes a locking mechanism configured to hold the internal temperature-sensitive, electrically conductive component in the second shape when the battery cell cools.

Yet another aspect of the disclosure provides a battery pack includes a plurality of battery cells. Each battery cell includes a case, a terminal, an electrode stack, a current collector electrically coupled to the electrode stack, and an internal temperature-sensitive, electrically conductive component. The internal temperature-sensitive, electrically conductive component is configured to, when having a temperature that satisfies a temperature threshold, change from a first shape to a second shape different from the first shape to disable the battery cell by electrically disconnecting the current collector from the terminal and electrically coupling the terminal to the case.

Implementations of the disclosure may include one or more of the following optional features. In some implementations, each battery cell also includes a second terminal, a second current collector electrically coupled to the electrode stack, and a second internal temperature-sensitive, electrically conductive component. The second internal temperature-sensitive, electrically conductive component is configured to, when having a third temperature that does not satisfy a second temperature threshold, have a third shape, and, when having a fourth temperature that satisfies the second temperature threshold, change from the third shape to a fourth shape different from the third shape to electrically couple the second terminal to the case. In some examples, the battery pack is configured to provide an electric voltage while one or more of the battery cells are disabled.

### BRIEF DESCRIPTION OF THE DRAWINGS

The drawings described herein are for illustrative purposes only of selected configurations and are not intended to limit the scope of the present disclosure.

FIG. 1 is a view of an example vehicle including a propulsion system having a battery pack in accordance with the principles of the present disclosure.

FIG. 2 is a schematic view of the propulsion system of FIG. 1.

FIG. 3A is an exploded view of a portion of an example battery cell.

FIG. 3B is a side cross-sectional view of the portion of the battery cell when the battery cell has a first temperature.

FIG. 3C is a side cross-sectional view of the portion of the battery cell when the battery cell has a second temperature.

FIG. 4A is an exploded view of a portion of another example battery cell.

FIG. 4B is a side cross-sectional view of the portion of the battery cell when the battery cell has a first temperature.

FIG. 4C is a side cross-sectional view of the portion of the battery cell when the battery has a second temperature.

FIGS. 5A-5D illustrate example internal temperature-sensitive, electrically conductive switches.

FIGS. 6A-6D illustrate example locking mechanisms for internal temperature-sensitive, electrically conductive switches.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

Electric vehicles (EVs) and hybrid electric vehicles (HEVs) include one or more electric motors and one or more battery packs configured to provide electric voltages for powering the electric motor(s) to propel the vehicle or to provide other electric voltages used by other components of the vehicle. Typically, the battery pack includes a plurality of battery cells. Thermal runaway in a battery pack may occur when an increase in temperature in one battery cell causes an increase in the temperature(s) of one or more other battery cells of the battery pack. This phenomenon may occur, for example, when a battery cell of the battery pack experiences an internal short circuit, overcharging, or physical damage. The heat may, in some examples, then trigger other reactions within the battery cell that may cause it to release even more heat. As the temperature of the battery cell continues to rise, adjacent battery cells may also overheat, causing the battery pack to experience a thermal runaway event that may cause the battery pack to experience a fault or failure. Therefore, there is a need for improved thermal control for the battery cells of a battery pack to prevent thermal runaway.

In disclosed configurations, each battery cell of a battery pack includes one or more internal temperature-sensitive, electrically conductive components that are configured to, when a temperature of a battery cell exceeds a temperature threshold (e.g., a temperature threshold slightly above a thermal runaway onset temperature of, for example, 120° C.-150° ), change its physical shape to disable the battery cell by disconnecting the current collector(s) and/or electrode stack(s) of the battery cell and creating a closed circuit through a resistive cover or case of the battery cell. This prevents the battery cell from experiencing further heating and prevents or slows down the heating of adjacent battery cells of the battery pack, thus, preventing the battery pack from experiencing a thermal runaway event. Advantageously, the other battery cells of the battery pack can continue to provide the power needed to propel the vehicle or to power other components of the vehicle even while the overheated battery cell is isolated.

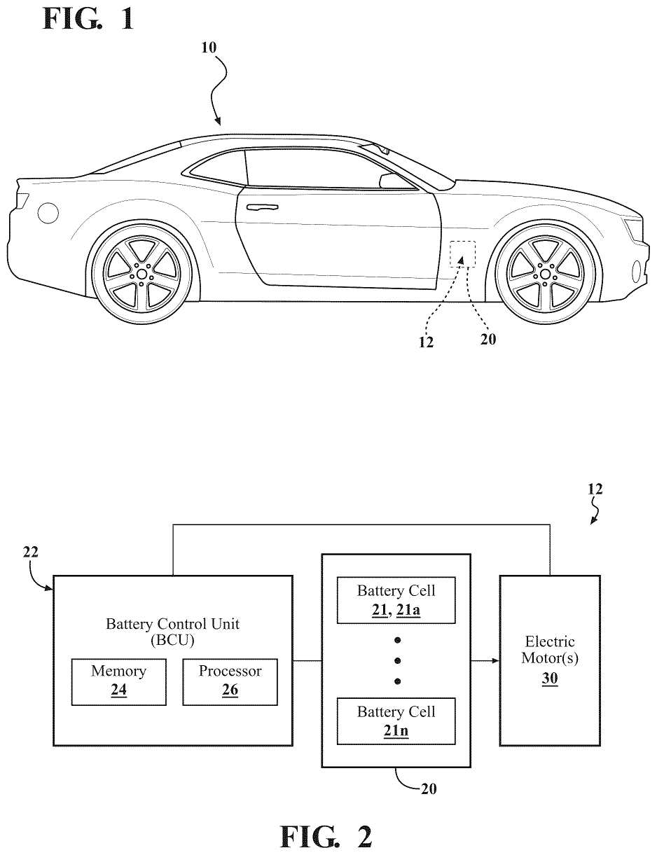

While configurations are shown and described herein in connection with the battery cells of a battery pack for a vehicle (e.g., an automobile, a truck, an airplane, a train, a motorcycle, etc.), it should be understood that disclosed configurations may additionally, or alternatively, be used for providing thermal control for battery cells of a battery pack used to power any other type of device, and/or for any other type of rechargeable energy storage system (RESS) With particular reference to FIGS. 1 and 2, a vehicle 10 (e.g., an automobile, a truck, an airplane, a train, a motorcycle, etc.) is shown in conjunction with a propulsion system 12 for propelling the vehicle 10. The vehicle 10 may be, for example an EV or a HEV. The propulsion system 12 includes a battery pack 20 having a plurality of battery cells 21, 21a-n, one or more electric motors 30, and a battery control unit (BCU) 22 for controlling the battery pack 20 and the electric motor(s) 30 to propel the vehicle 10. The battery cells 21 may be coupled in series and/or in parallel. The battery pack 20 may additionally, or alternatively, be used to power other components of the vehicle 10. The BCU 22 stores machine-readable instructions on, for example, memory hardware 24. The instructions may be executed by data processing hardware 26 (e.g., a processor) of the BCU 22 to perform the operations of the BCU 22.

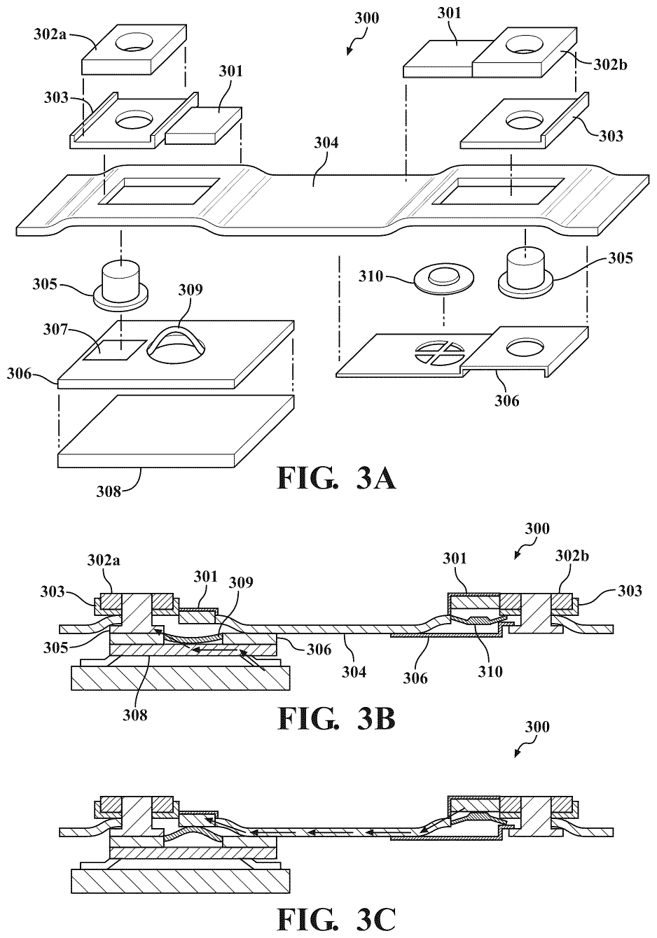

FIG. 3A is an exploded view of a portion of an example battery cell 300 that may be used to implement the battery cells 21 of the battery pack 20. FIG. 3B is a side cross-sectional view of the portion of the battery cell 300 when the battery cell 300 has a first temperature that is less than a temperature threshold (e.g., a temperature threshold slightly above a thermal runaway onset temperature of, for example, 120° C.-150° C.). FIG. 3C is a side cross-sectional view of the portion of the battery cell 300 when the battery cell 300 has a second temperature that is greater than the temperature threshold and is disabled. The battery cell 300 includes terminals 302a and 302b, an external insulator and sealing component 303, a cover or case 304, rivets 305, inner insulators 306, a current collector 308, an internal temperature-sensitive, electrically conductive switch 309 (also referred to herein as switch 309), a connector 307 between the rivet 305 and the switch 309, and another internal temperature-sensitive, electrically conductive switch 310 (also referred to herein as switch 310). In the illustrated example, the terminal 302a is a negative terminal of the battery cell 300 and the terminal 302b is a positive terminal of the battery cell 300. However, the terminal 302a may be a positive terminal of the battery cell 300 and the terminal 302b may be a negative terminal of the battery cell 300.

Because, in FIG. 3B, a first temperature of the battery cell 300 (e.g., a first temperature of the switch 309) is less than the temperature threshold, the switch 309 is configured to have a first shape (e.g., bowed or deflected downward) that electrically couples the current collector 308 to the terminal 302a. In FIG. 3B, the case 304 is neutral. However, because in FIG. 3C, a second temperature of the battery cell 300 (e.g., a second temperature of the switch 309) is greater than the temperature threshold, the switch 309 is configured to have a second shape (e.g., bowed or deflected upward) different from the first shape that disables the battery cell 300 by electrically disconnecting the current collector 308 from the terminal 302a and electrically coupling the terminal 302a to the case 304. In FIG. 3C, when the switch 310 has a third temperature that is greater than the temperature threshold, the switch 310 is configured to have a second shape that is different from a first shape shown in FIG. 3B to electrically couple the terminal 302b to the case 304.

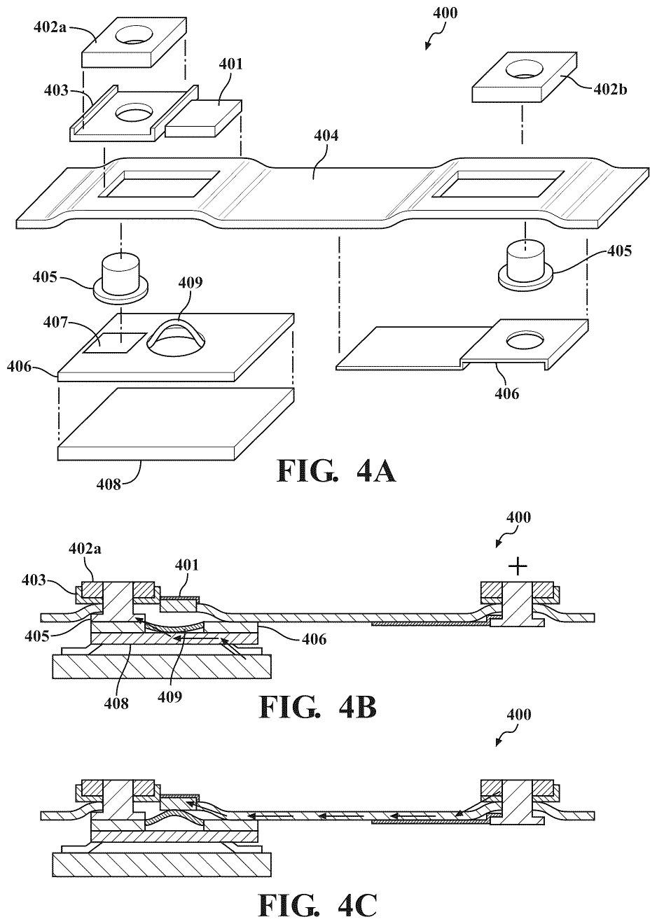

FIG. 4A is an exploded view of a portion of another example battery cell 400 that may be used to implement the battery cells 21 of the battery pack 20. FIG. 4B is a side cross-sectional view of the portion of the battery cell 400 when the battery cell 400 has a first temperature that is less than a temperature threshold (e.g., a temperature threshold slightly above a thermal runaway onset temperature of, for example, 120° C.-150° C.). FIG. 4C is a side cross-sectional view of the portion of the battery cell 400 when the battery cell 400 has a second temperature that is greater than the temperature threshold and is disabled. The battery cell 400 includes terminals 402a and 402b, an external insulator and sealing component 403, a cover or case 404, rivets 405, an inner insulator 406, a current collector 408, an internal temperature-sensitive, electrically conductive switch 409 (also referred to herein as switch 409), and a connector 407 between the rivet 405 and the switch 409. In the illustrated example, the terminal 402a is a negative terminal of the battery cell 400, the terminal 402b is a positive terminal of the battery cell 400, and the case 404 is electrically coupled to the terminal 402b. However, the terminal 402a may be a positive terminal of the battery cell 400 and the terminal 402b may be a negative terminal of the battery cell 400, with the case 404 electrically coupled to the negative terminal.

Because, in FIG. 4B, a first temperature of the battery cell 400 (e.g., a first temperature of the switch 409) is less than the temperature threshold, the switch 409 is configured to have a first shape (e.g., bowed or deflected downward) that electrically couples the current collector 408 to the terminal 402a. However, because in FIG. 4C, a second temperature of the battery cell 400 (e.g., a second temperature of the switch 409) is greater than the temperature threshold, the switch 409 is configured to have a second shape (e.g., bowed or deflected upward) different from the first shape that disables the battery cell 400 by electrically disconnecting the current collector 408 from the terminal 402a and electrically coupling the terminal 402a to the case 404.

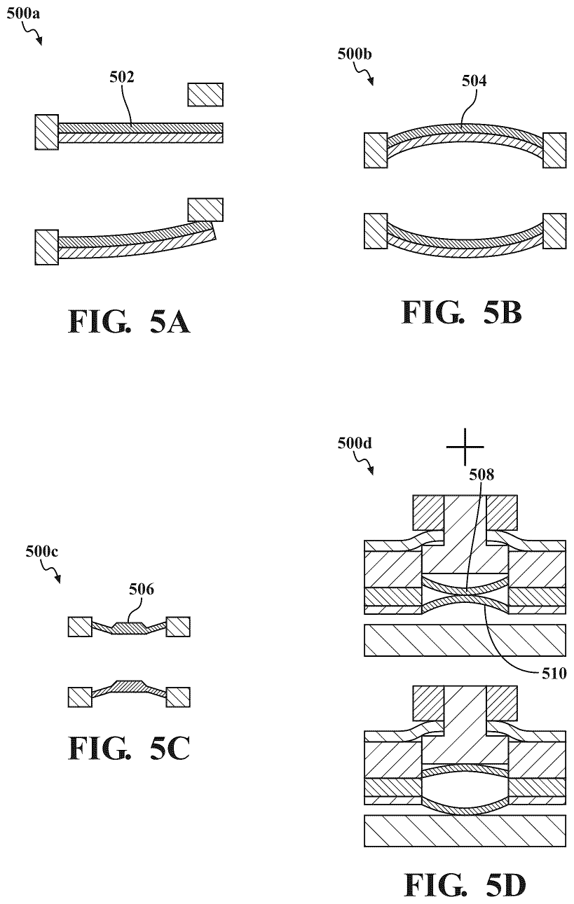

FIGS. 5A-5D illustrate example internal temperature-sensitive, electrically conductive switches 500, 500a-d (also referred to herein as switches 500). The switch 500a of FIG. 5A includes a bimetallic strip 502 that is configured to change shape as a temperature of the switch 500a changes. In particular, the bimetallic strip 502 is configured to be flat when a first temperature of the switch 500a is less than a temperature threshold (e.g., a temperature threshold slightly above a thermal runaway onset temperature of, for example, 120° C.-150° C.) and to be curved or deflected upward when a second temperature of the switch 500a is greater than the temperature threshold.

The switch 500b of FIG. 5B includes a bimetallic strip 504 that is configured to change shape as a temperature of the switch 500b changes. In particular, the bimetallic strip 504 is configured to bow or bend upward when a first temperature of the switch 500b is less than a temperature threshold (e.g., a temperature threshold slightly above a thermal runaway onset temperature of, for example, 120° C.-150° C.) and to bow or bend downward when a second temperature of the switch 500b is greater than the temperature threshold.

The switch 500c of FIG. 5C includes a shape memory alloy 506 that is configured to undergo a phase transformation as the temperature of the switch 500c changes. In particular, the shape memory alloy 506 is configured to bow downward when a first temperature of the switch 500c is less than a temperature threshold (e.g., a temperature threshold slightly above a thermal runaway onset temperature of, for example, 120° C.-150° C.) and to bow upward when a second temperature of the switch 500c is greater than the temperature threshold.

The switch 500d includes a pair of sub-components 508 and 510 that are configured to change shape as the temperature of the switch 500d changes. In particular, the sub-components 508 and 510 are configured to bow or bend away from each other when a first temperature of the switch 500d is less than a temperature threshold (e.g., a temperature threshold slightly above a thermal runaway onset temperature of, for example, 120° C.-150° C.) and to bow or bend toward each other when a second temperature of the switch 500d is greater than the temperature threshold.

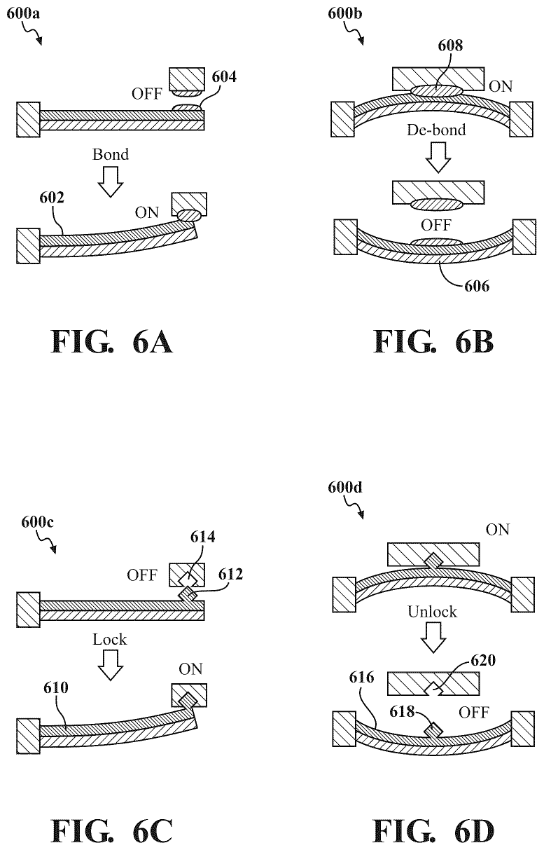

FIGS. 6A-6D illustrate example locking or holding mechanisms for internal temperature-sensitive, electrically conductive switches 600, 600a-d (also referred to herein as switches 600). In the illustrated example of FIG. 6A, when the temperature of the switch 600a is greater than a temperature threshold (e.g., a temperature threshold slightly above a thermal runaway onset temperature of, for example, 120° C.-150° C.), a bimetallic strip 602 is configured to deflect upward and low-melting-point solder 604 is configured to melt to retain or secure the bimetallic strip 602 in the upward position even after the switch 600a cools, thereby, locking a battery cell 21 that includes the switch 600a in a disabled state.

In the illustrated example of FIG. 6B, a bimetallic strip 606 of the switch 600b is held or secured in an upward bowed position by low-melting-point solder 608 when a temperature of the switch 600b is less than a temperature threshold (e.g., a temperature threshold slightly above a thermal runaway onset temperature of, for example, 120° C.-150° C.) to secure a battery cell 21 that includes the switch 600b in an active state. When the temperature of the switch 600b is greater than the temperature threshold, the solder 608 is configured to melt and the bimetallic strip 606 is configured to bend downward in response to the increased temperature.

In the illustrated examples of FIG. 6C, when the temperature of the switch 600c is greater than a temperature threshold (e.g., a temperature threshold slightly above a thermal runaway onset temperature of, for example, 120° C.-150° C.), a bimetallic strip 610 is configured to deflect upward such that a mechanical feature 612 of the bimetallic strip 610 engages another mechanical feature 614 of the switch 600c to retain the bimetallic strip 610 in the upward position even after the switch 600c cools, locking a battery cell 21 that includes the switch 600c in a disabled state.

In the illustrated example of FIG. 6D, when the temperature of the switch 600d is less than a temperature threshold (e.g., a temperature threshold slightly above a thermal runaway onset temperature of, for example, 120° C.-150° C.), a bimetallic strip 616 is held in an upward bowed position by the engagement of a mechanical feature 618 of the bimetallic strip 616 with another mechanical feature 620 of the switch 600d to secure a battery cell 21 that includes the switch 600d in an active state. When the temperature of the switch 600d is greater than the threshold temperature, the downward bending force of the bimetallic strip 616 disengages the features 618 and 620.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
an electric motor; and
a battery pack configured to provide an electric voltage for powering the electric motor to propel the vehicle, the battery pack comprising a plurality of battery cells, each battery cell comprising:
a case;
a terminal;
an electrode stack;
a current collector electrically coupled to the electrode stack; and
an internal temperature-sensitive electrically conductive component configured to:
when having a first temperature that does not satisfy a temperature threshold, have a first shape that electrically couples the current collector to the terminal; and
when having a second temperature that satisfies the temperature threshold, change from the first shape to a second shape different from the first shape to disable the battery cell by electrically disconnecting the current collector from the terminal and electrically coupling the terminal to the case.

2. The vehicle of claim 1, wherein the terminal comprises a negative terminal of the battery cell.

3. The vehicle of claim 1, wherein each battery cell further comprises:
a second terminal;
a second current collector electrically coupled to the electrode stack; and
a second internal temperature-sensitive, electrically conductive component configured to:
when having a third temperature that does not satisfy a second temperature threshold, have a third shape; and
when having a fourth temperature that satisfies the second temperature threshold, change from the third shape to a fourth shape different from the third shape to electrically couple the second terminal to the case.

4. The vehicle of claim 3, wherein:
the terminal comprises a negative terminal of the battery cell; and
the second terminal comprises a positive terminal of the battery cell.

5. The vehicle of claim 1, wherein the case is electrically coupled to a second terminal of the battery cell.

6. The vehicle of claim 1, wherein the internal temperature-sensitive, electrically conductive component comprises a shape-memory alloy configured to undergo a phase transformation when the internal temperature-sensitive, electrically conductive component has the second temperature that satisfies the temperature threshold.

7. The vehicle of claim 1, wherein the internal temperature-sensitive, electrically conductive component comprises a bimetallic strip configured to deflect when the internal temperature-sensitive, electrically conductive component has the second temperature that satisfies the temperature threshold.

8. The vehicle of claim 1, wherein the internal temperature-sensitive, electrically conductive component comprises a bimetallic strip configured to bend when the internal temperature-sensitive, electrically conductive component has the second temperature that satisfies the temperature threshold.

9. The vehicle of claim 1, wherein the internal temperature-sensitive, electrically conductive component comprises two sub-components configured to:
bend away from each other when the internal temperature-sensitive, electrically conductive component has the first temperature that does not satisfy the temperature threshold; and
bend toward each other when the internal temperature-sensitive, electrically conductive component has the second temperature that satisfies the temperature threshold.

10. The vehicle of claim 1, wherein each battery cell further comprises a locking mechanism configured to hold the internal temperature-sensitive, electrically conductive component in the second shape when the battery cell cools.

11. The vehicle of claim 1, wherein the battery pack is configured to continue to provide the electric voltage or a second electric voltage while one or more of the battery cells are disabled.

12. A battery cell for a battery pack, the battery cell comprising:
a case;
a terminal;
an electrode stack;
a current collector electrically coupled to the electrode stack; and
an internal temperature-sensitive, electrically conductive component configured to:
when having a first temperature that does not satisfy a temperature threshold, have a first shape that electrically couples the current collector to the terminal; and
when having a second temperature that satisfies the temperature threshold, change from the first shape to a second shape different from the first shape to disable the battery cell by electrically disconnecting the current collector from the terminal and electrically coupling the terminal to the case.

13. The battery cell of claim 12, wherein the terminal comprises a negative terminal of the battery cell.

14. The battery cell of claim 12, further comprising:
a second terminal;
a second current collector electrically coupled to the electrode stack; and
a second internal temperature-sensitive, electrically conductive component configured to:
when having a third temperature that does not satisfy a second temperature threshold, have a third shape; and
when having a fourth temperature that satisfies the second temperature threshold, change from the third shape to a fourth shape different from the third shape to electrically couple the second terminal to the case.

15. The battery cell of claim 14, wherein:
the terminal comprises a negative terminal of the battery cell; and
the second terminal comprises a positive terminal of the battery cell.

16. The battery cell of claim 12, wherein the case is electrically coupled to a second terminal of the battery cell.

17. The battery cell of claim 12, further comprising a locking mechanism configured to hold the internal temperature-sensitive, electrically conductive component in the second shape when the battery cell cools.

18. A battery pack comprising a plurality of battery cells, each battery cell comprising:
a case;
a terminal;
an electrode stack;
a current collector electrically coupled to the electrode stack; and
an internal temperature-sensitive, electrically conductive component configured to, when having a temperature that satisfies a temperature threshold, change from a first shape to a second shape different from the first shape to disable the battery cell by electrically disconnecting the current collector from the terminal and electrically coupling the terminal to the case.

19. The battery pack of claim 18, wherein each battery cell further comprises:
a second terminal;
a second current collector electrically coupled to the electrode stack; and
a second internal temperature-sensitive, electrically conductive component configured to:
when having a third temperature that does not satisfy a second temperature threshold, have a third shape; and
when having a fourth temperature that satisfies the second temperature threshold, change from the third shape to a fourth shape different from the third shape to electrically couple the second terminal to the case.

20. The battery pack of claim 18, wherein the battery pack is configured to provide an electric voltage while one or more of the battery cells are disabled.
